(19) United States
(12) Patent Application Publication
(10) Pub. No.: US 2008/0248381 A1
(43) Pub. Date: Oct. 9, 2008

(54) Ceramic Separator for Electrochemcial Cells With Improved Conductivity

(75) Inventors: Volker Hennige, Dulmen (DE); Christian Hying, Rhede (DE); Gerhard Horpel, Nottuln (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Degussa AG, Dueseldorf (DE)

(21) Appl. No.: 10/575,274

(22) PCT Filed: Aug. 19, 2004
(86) PCT No.: PCT/EP2004/051844

§ 371 Date: Apr. 11, 2006

(30) Foreign Application Priority Data
Oct. 14, 2003 (DE) 10347566.4

(51) Int. Cl. H01M 2/16; H01M 2/00

(52) U.S. Cl. 429/129; 427/383.1

(57) ABSTRACT

Separator for an electrochemical cell comprising a flexible perforate carrier having a ceramic coating on and in the carrier, the ceramic coating comprising from 75 to 99 parts by mass of oxidic particles selected from particles of ZrO₂, SiO₂ and Al₂O₃ and comprising from 1 to 25 parts by mass of zeolite particles. These separators exhibit distinctly improved ion conductivity after filling with an electrolyte and are useful as separators in lithium ion batteries in particular.

The present invention relates to a separator for an electrochemical cell, a process for producing such a separator and also an electrochemical cell which comprises such a separator.

As used herein, electrochemical cell or battery refers to batteries and accumulators (secondary batteries) of any kind, especially alkali metal such as for example lithium, lithium ion, lithium polymer, and alkaline earth metal batteries and accumulators, in the form of high energy or high power systems.

Electrochemical cells comprise electrodes of opposite polarity which are separated from each other by a separator while maintaining ion conductivity.

A separator is conventionally a thin porous electroinsulating material possessing high ion permeability, good mechanical strength and long-term stability to the chemicals and solvents used in the system, for example in the electrolyte of the electrochemical cell. In electrochemical cells, the separator should fully electronically insulate the cathode from the anode. Moreover, the separator has to be permanently elastic and to follow movements in the system, for example in the electrode pack in the course of charging and discharging.

The separator is a crucial determinant of the use life of the system in which it is used, for example the use life of an electrochemical cell. The development of rechargeable electrochemical cells or batteries is therefore influenced by the development of suitable separator materials. General information about electrical separators and batteries may be found for example at J. O. Besenhard in “Handbook of Battery Materials” (VCH-Verlag, Weinheim 1999).

High energy batteries are employed in various applications where the decisive requirement is that a very large amount of electrical energy be available. This is the case for example with traction batteries, but also with auxiliary power systems. The energy density is frequently reported in this field per unit weight [Wh/kg] or per unit volume [Wh/L]. Currently, high energy batteries reach energy densities of 350 to 400 Wh/L and of 150 to 200 Wh/kg. The power levels which such batteries are expected to supply are not that high, so that compromises can be made with regard to the internal resistance. In other words, the conductivity of the electrolyte-filled separator for example does not have to be as large as in the case of high power batteries, for example, so that the way is open to the use of other separator designs.

High energy systems, for instance, can even utilize polymer electrolytes whose conductivity at 0.1 to 2 mS/cm is fairly low. Such polymer electrolyte cells cannot be used as high power batteries.

Separator materials for use in high power battery systems have to have the following properties:

They need to be very thin to ensure low specific space requirements and to minimize the internal resistance. To ensure these low internal resistances, it is important that the separator also has a high porosity. Further, they have to be light in order that a low specific weight may be achieved. In addition, wettability has to be high, since otherwise unwetted dead zones are formed.

There are many applications, especially mobile applications, where very large amounts of energy are required, eg in traction batteries. The batteries in these applications thus store large amounts of energy in the fully charged state. The separator has to be safe for these batteries, since very large specific electric energy quantities are transported in these batteries. These energies must not in any way be released in an uncontrolled fashion in the event of a dysfunction of the battery, such as for example overcharging or short circuiting, or of an accident, since this would ineluctably lead to the cell exploding and going up in flames.

Currently used separators consist predominantly of porous organic polymeric films or of inorganic nonwoven web materials, for example webs composed of glass or ceramic materials or else ceramic papers. These are manufactured by various companies. Important producers here are: Celgard, Tonen, Ube, Asahi, Binzer, Mitsubishi, Daramic and others.

Separators composed of inorganic nonwovens or of ceramic paper are mechanically very unstable and lead easily to short circuiting, meaning that long use lifes cannot be achieved.

A typical organic separator consists for example of polypropylene or of a polypropylene-polyethylene-polypropylene composite. A substantial disadvantage of these organic polyolefin separators is their relatively low thermal stability limit of below 150° C. Even brief attainment of the melting point of these polymers leads to substantial melting of the separator and to short circuiting in the electrochemical cell utilizing such a separator. The use of such separators is therefore generally not safe. This is because when higher temperatures are attained, especially temperatures of at least 150° C. or even at least 180° C., these separators are destroyed.

There have been initial attempts to use inorganic composite materials as separators in order to overcome these disadvantages. For instance, DE 198 38 800 C1 proposes an electrical separator having a composite structure that comprises a sheetlike flexible substrate having a multiplicity of openings and having a coating on the substrate. The material for the substrate is selected from metals, alloys, plastics, glass and carbon fiber or a combination thereof, and the coating is a two-dimensionally continuous porous electrically nonconducting ceramic coating. The use of the ceramic coating promises thermal and chemical stability. The separators, which as exemplified comprise a carrier or substrate composed of electrically conductive material, however, have been determined to be unsuitable for electrochemical cells, since the coating has proved impossible to produce over a large area without flaws at the thickness described and consequently short circuiting can occur very easily. Nor are such thin metal fabrics as required for very thin separators commercially available.

It has been shown in previous work (DE 101 42 622) that a material comprising a sheetlike flexible substrate having a multiplicity of openings and having a coating on and in this substrate, the material of the substrate being selected from woven or non-woven nonelectroconductive fibers of glass or ceramic or a combination thereof and the coating being a porous electrically insulating ceramic coating, can be used to produce a separator which has a thickness of less than 100 μm and is bendable, the resulting separator having a sufficiently low resistance in connection with the electrolyte and yet possessing sufficiently good long-term stability. The separator described in DE 101 42 622 possesses very high conductivity, but the separator described therein still does not meet the requirements of an industrially useful separator with regard to thickness and weight and also safety.

In the DE 102 08 277 application, the weight and thickness of the separator was reduced by using a polymeric nonwoven, but the separator embodiments described therein likewise still do not meet all the requirements of a separator for a lithium high energy battery, especially because particular emphasis was placed in this application on very large pores for the separator. But the particles described therein, up to 5 μm in size, do not permit the production of separators 10 to 40 μm in thickness, since only few particles would come to rest on top of each other here. As a result, the separator would inevitably have a large defective and disruptive site density (eg holes, cracks, . . . ).

DE 102 55 122, unpublished at the priority date of the present invention, discloses enhancing the durability of separators by endowing the pores in the ceramic coating with fine particles selected from SiO₂, Al₂O₃, ZrO₂, SiC, Li₂CO₃, Li₃N, LiAlO₂, or LiₓAl_{y}Ti_{z}(PO₄)₃ where 1≦x≦2, 0≦y≦1 and 1≦z≦2. This measure did indeed succeed in improving the long-term stability of such separators. However, there continues to be a need to improve the ion conductivity of ceramic or semiceramic separators.

It is an object of the present invention to provide an electrochemical cell separator which has further improved ion conductivity and therefore is very useful for lithium high power batteries in particular.

It has now been found that, surprisingly, a significant increase in the conductivity of the electrolyte-saturated separator is achieved for ceramic separators when at least a portion of the oxides customarily used as ceramic particles, examples being Al₂O₃, SiO₂ or ZrO₂, is replaced by zeolite particles. Why replacing at least a portion of the ceramic particles by zeolite particles should lead to this increase is as yet not fully understood.

DE 100 55 612 and WO 02/38259 describe the production of membranes which are based on ceramic-coated carrier materials, such as polyamide wovens or nonwovens for example, and which comprise zeolites as active (separating) layers, but separators are not described therein. Moreover, in the systems described therein, the active layer is produced in a very costly and inconvenient manner, namely by zeolite synthesis within the membrane.

The present invention accordingly provides a separator for electrochemical cells, especially a battery separator, comprising a porous carrier which comprises woven or non-woven polymeric fibers having on and in this carrier a porous inorganic nonelectroconductive coating comprising particles having an average particle size in the range from 0.5 to 10 μm which are adhered to each other and to the carrier by an inorganic adhesive, characterized in that the inorganic coating comprises from 75 to 99 parts by mass of one or more oxidic particles of the elements Al, Si and/or Zr having an average particle size in the range from 0.5 to 10 μm and from 1 to 25 parts by mass of particles having an average particle size in the range from 0.5 to 10 μm of at least one zeolite.

The present invention likewise provides a process for producing a separator as per the invention, characterized in that it comprises a carrier which comprises woven or non-woven polymeric fibers being provided with a ceramic coating by a suspension being applied onto and into the carrier and being solidified on and in the carrier by at least single heating, the suspension comprising a sol and at least two fractions of particles of which the first fraction comprises oxidic particles having an average particle size in the range from 0.5 to 10 μm selected from the oxides of the elements Al, Zr and/or Si and comprises from 75 to 99 parts by mass and of which the second fraction comprises zeolite particles having an average particle size in the range from 0.5 to 10 μm and comprises from 1 to 25 parts by mass.

The present invention further provides for the use of an inventive separator as separator in batteries and also batteries, especially lithium ion batteries, comprising a separator according to the present invention.

The separators of the present invention have the advantage that separators thus endowed with zeolites are equivalent to prior art separators with regard to porosities, pore sizes, Gurley numbers, etc., but have a MacMullin number which is significantly increased, by up to a factor of 2. But a high McMullin number also signifies a high ion conductivity.

The separator of the present invention and a process for producing it is described in what follows without wishing to restrict the invention to these embodiments.

The inventive separator for electrochemical cells comprising a porous carrier which comprises woven or non-woven polymeric fibers having on and in this carrier a porous inorganic nonelectroconductive coating comprising particles having an average particle size in the range from 0.5 to 10 μm which are adhered to each other and to the carrier by an inorganic adhesive is characterized in that the inorganic coating comprises from 75 to 99 parts by mass, preferably from 80 to 90 parts by mass, of one or more oxidic particles of the elements Al, Si and/or Zr having an average particle size in the range from 0.5 to 10 μm and from 1 to 25 parts by mass, preferably from 10 to 20 parts by mass, of particles having an average particle size in the range from 0.5 to 10 μm of at least one zeolite. When the 25 parts by mass of zeolite particles is exceeded, the mechanical properties of the separators deteriorate, so that they can no longer be sensibly used in batteries.

The zeolites in the zeolite particles present in the separator may be in the H⁺, Na⁺ or Li⁺ form. Useful zeolites include in principle all known zeolites. Preferably, the less hydrophobic types are present in the inorganic coating. The separator of the present invention preferably comprises as zeolite particles particles selected from the zeolites Zeolite-A, Zeolite-Y or Zeolite-USY. Table 1 below indicates some data for zeolites from Degussa AG (Wessalith P) and for the zeolyst (CBVxxxx). However, other zeolites known from the prior art can be used as well.

TABLE 1
Some zeolites with selected data

| | | | Exchange | |
|---|---|---|---|---|
| | | | capacity | Relative |
| Designation | Name | SiO₂/Al₂O₃* | meq/g | hydrophobicity |
| A | Wessalith P | 1.3 | 11.2 | <0.1 |
| Y | CBV600 | 5.2 | 4.8 | 1.8 |
| USY | CBV720 | 30 | 1.05 | 2.6 |
| ZSM 5 | CBV3024 | 30 | 1.05 | 3 |
| ZSM9 | CBV30014 | 300 | ≈0 | 25 |

*molar ratio

The separators of the present invention preferably comprise carriers which are flexible and preferably less than 50 μm in thickness. The flexibility of the carrier ensures that the separator of the present invention can be flexible too. Such flexible separators have more diverse potential applications, for example in wound cells. The thickness of the carrier has a substantial bearing on the properties of the separator, since not only the flexibility but also the sheet resistance of the electrolyte-saturated separator is dependent on carrier thickness.

Preferably, therefore, the separator of the present invention comprises carriers which are less than 30 μm and more preferably less than 20 μm in thickness. To be able to achieve sufficiently high battery performance, especially in the case of lithium ion batteries, it has been determined to be advantageous for the separator of the present invention to comprise a carrier whose porosity is preferably above 40%, more preferably in the range from 50% to 97%, even more preferably in the range from 60% to 90% and most preferably in the range from 70% to 90%. Porosity in this context is defined as the volume of the carrier (100%) minus the volume of the fibers of the carrier, i.e., the fraction of the volume of the carrier that is not taken up by material. The volume of the carrier can be calculated from the dimensions of the carrier. The volume of the fibers is calculated from the measured weight of the nonwoven in question and the density of the fibers and especially of the polymeric fibers. In a further embodiment of the invention, the carrier is a nonwoven having a pore size in the range from 5 to 500 μm and preferably in the range from 10 to 200 μm.

The porous (perforate) carrier preferably comprises woven or non-woven polymeric fibers. More preferably, the carrier comprises a polymeric woven or nonwoven or is such a woven or nonwoven. The polymeric fibers in the carrier are preferably nonelectroconductive fibers of polymers which are preferably selected from polyacrylonitrile (PAN), polyamide (PA), polyester, for example polyethylene terephthalate (PET), and/or polyolefin (PO), for example polypropylene (PP) or polyethylene (PE) or mixtures of such polyolefins. When the perforate carrier comprises polymeric fibers, however, polymeric fibers other than those mentioned above can be used as well, as long as they have the requisite thermostability for the production of the separators and also are stable under the operating conditions in an electrochemical cell, preferably a lithium battery. In a preferred embodiment, the separator of the present invention comprises polymeric fibers having a softening temperature of above 100° C. and a melting temperature of above 110° C. The carrier may comprise fibers and/or filaments from 0.1 to 150 μm and preferably from 1 to 20 μm in diameter and/or threads from 3 to 150 μm and preferably from 10 to 70 μm in diameter. When the carrier comprises polymeric fibers, these are preferably from 0.1 to 10 μm and more preferably from 1 to 5 μm in diameter. Particularly preferred flexible nonwovens, especially polymeric nonwovens, have a basis weight of less than 20 g/m² and preferably in the range from 5 to 15 g/m². This ensures a particularly low thickness and a high flexibility for the carrier.

It is particularly preferable for the separator of the present invention to comprise a carrier which is a polymeric nonwoven which is less than 30 μm and preferably from 10 to 20 μm in thickness. A very homogeneous pore radius distribution in the nonwoven is particularly important for use in a separator according to the present invention. A very homogeneous pore radius distribution in the nonwoven leads in conjunction with optimally adapted oxidic particles of a certain size to an optimized porosity for the separator according to the present invention.

The inorganic adhesive in the separator of the present invention is preferably selected from oxides of the elements Al, Si and/or Zr. The inorganic adhesive may comprise particles having an average particle size of less than 20 nm and may have been prepared via a particulate sol or comprise an inorganic network of oxides which was prepared via a polymeric sol.

It can be advantageous for the separator of the present invention to additionally comprise an inorganic network comprising silicon, the silicon of the network being bonded via oxygen atoms to the oxides of the inorganic coating and via an organic radical to the carrier which comprises polymeric fibers. Such a network is obtained when an adhesion promoter is used in the production of the separator and this adhesion promoter is subjected to the thermal treatment customary in the production process.

Preferably, the separator of the present invention comprises on and in the carrier a porous, electrically insulating, inorganic coating which comprises oxidic particles of the elements Al, Si and/or Zr having an average particle size of preferably 1 to 4 μm. It is likewise preferable for the separator of the present invention to comprise zeolite particles having an average particle size in the range from 1 to 5 μm. It is particularly preferable for the particles to be adhered together using an oxide of the metals Zr or Si. The inventive separator's ceramic material formed by the particles and the inorganic adhesive preferably has an average pore size in the range from 50 nm to 5 μm and more preferably in the range from 100 to 1000 nm.

The separators of the present invention are bendable without damage preferably down to any radius down to 100 m, preferably to a radius in the range from 100 m down to 50 mm and most preferably to a radius in the range from 50 mm down to 2 mm. The separators of the present invention are also notable for a breaking strength of at least 1 N/cm, preferably at least 3 N/cm and most preferably above 6 N/cm. The high breaking strength and the good bendability of the separator according to the present invention has the advantage that the separator is able to keep up with electrode geometry changes occurring in the course of the charging and the discharging of the battery without the separator becoming damaged. The bendability, moreover, has the advantage that commercially, standardized wound cells can be manufactured using this separator. With these cells, the electrode-separator plies are spirally wound up with each other in standardized size and contacted.

The separator of the present invention has a porosity which is preferably in the range from 30% to 80%. Porosity here refers to the accessible, i.e., open, pores. Porosity in this sense can be determined by the familiar method of mercury porosimetry or can be calculated from the volume and the density of the ingredients used on the assumption that open pores only are present.

The separators of the present invention are preferably less than 50 μm, more preferably less than 40 μm, even more preferably from 5 to 30 μm and most preferably from 15 to 25 μm in thickness. Separator thickness has a large bearing on separator properties, since not only the flexibility but also the sheet resistance of the electrolyte-saturated separator is dependent on the thickness of the separator. The low thickness ensures a particularly low electrical resistance for the separator in use with an electrolyte. The separator itself does of course have a very high electrical resistance, since it itself has to have insulating properties. Moreover, thinner separators permit an increased pack density in the battery stack, so that a larger amount of energy can be stored in the same volume.

The separator of the present invention is by virtue of its construction according to the invention very useful for electrochemical cells possessing high capacity and high energy density. More particularly, the separator according to the invention is useful for electrochemical cells which are based on the transference of alkali and/or alkaline earth metal ions, such as lithium metal and lithium ion batteries for example. It is therefore advantageous when these separators also possess the protective measures specific to these applications, such as shutdown and meltdown with a high short circuiting temperature. Shutdown refers to a measure in which the separator may have incorporated into it materials which are to be selected for certain operating temperatures and melt easily, such as thermoplastic materials for example. In the event of a rise in the operating temperature due to upsets such as overcharging or external or internal short circuiting, such easy-melting materials can melt and plug the pores of the separator. Thus the ion flux through the separator is partially or completely blocked and a further rise in the temperature is prevented. Meltdown refers to the property that the separator will melt completely at a short circuiting temperature. Large areas of the electrodes in an electrochemical cell can then come into contact and short circuit. A very high short circuiting temperature is desirable for safe operation of an electrochemical cell possessing high capacity and energy density. The separator according to the invention has an important advantage in this respect. This is because the ceramic material which adheres to the perforate carrier in the case of the separator of the present invention has a melting point which is far above the safety-relevant temperature range for electrochemical cells. The separator of the present invention therefore possesses outstanding safety.

Polymeric separators provide for example the safety demanded at present for lithium batteries by stopping any ion transport through the electrolyte from a certain temperature (the shutdown temperature of about 120° C.). This happens because at this temperature the pore structure of the separator collapses and all the pores are closed. Because ions can no longer be transported, the dangerous reaction which can lead to explosion ceases. But if the cell continues to undergo heating because of external circumstances, then the meltdown temperature is exceeded at about 150 to 180° C. At this temperature, the separator melts and contracts. Direct contact then comes about between the two electrodes at many places in the battery cell, leading to internal short circuiting over a large area. This leads to an uncontrolled reaction which ends with an explosion of the cell, or the resultant pressure is released by an overpressure valve (a bursting disk), frequently with signs of fire.

In the realm of the present invention, the flexible perforate carrier of the separator comprises polymeric fibers. This hybridic separator, comprising inorganic components and a polymeric carrier material, undergoes shutdown when the high temperature causes the polymeric structure on the carrier material to melt and to penetrate into the pores of the inorganic material, thereby closing them. But meltdown does not occur with the separator according to the present invention. The separator according to the present invention thus meets the requirements, voiced by various battery manufacturers, for a safety switchoff mechanism, by virtue of its shutdown mechanism in the battery cells. The inorganic particles ensure that there can never be a meltdown. It is thus ensured that there are no operating states where large-area short circuiting can occur.

The separator according to the invention is also very safe in the event of internal short circuiting due to an accident for example. If, for example, a nail were to puncture a battery, the following would happen, depending on the type of separator: a polymeric separator would melt at the site of puncture (a short circuit current flows through the nail and causes it to heat up) and contract. As a result, the short circuiting location will become larger and larger and the reaction would get out of control. Only the polymeric substrate material at most would melt in the case of the embodiment with the hybridic separator of the present invention, but not the inorganic separator material. So the reaction in the interior of the battery cell following such an accident would proceed much more moderately. This battery is thus distinctly safer than one with a polymeric separator. This is an important factor in mobile applications in particular.

It may be preferable for the separator to comprise an additional, noninherent shutdown mechanism. This additional, noninherent shutdown mechanism may be achieved for example when a very thin layer of waxy or polymeric shutdown particles, which melt at a desired shutdown temperature, is present on or in the separator. Particularly preferred materials for shutdown particles include for example natural or artificial waxes, low-melting polymers, for example polyolefins, the material for the shutdown particles being chosen so that the particles melt at the desired shutdown temperature and close the pores of the separator to prevent further ion flux.

Preferably, the shutdown particles have an average particle size (D_{w}) which is not less than the average pore size (dₛ) of the pores of the porous inorganic layer of the separator. This is advantageous in particular because this prevents penetration and closing of the pores of the separator layer that would result in a reduction in the pore volume and hence in separator conductivity and also battery performance. The thickness of the shutdown particle layer is only critical insofar as an excessively thick layer would increase the resistance in the battery system unnecessarily. To achieve safe shutdown, the shutdown particle layer should have a thickness (z_{w}) which is approximately in the range from the average particle size of the shutdown particles (D_{w}) up to 10 D_{w} and preferably in the range from 2 D_{w} to D_{w}. A thus equipped separator comprises a primary safety feature. In contrast to the all-organic separator materials, however, this separator cannot melt completely and there can never be a meltdown. These safety features are very important for high energy batteries owing to the very large energy quantities and therefore are frequently mandated.

In a further version of the separator according to the present invention, it comprises on the inorganic coating, which comprises oxidic particles of the elements Al, Si and/or Zr having an average particle size in the range from 0.5 to 10 μm and also zeolite particles, a porous shutdown layer composed of a material which melts at a predetermined temperature and closes the pores of the inorganic layer, the shutdown layer being formed by a porous sheetlike structure.

It is possible in principle for the shutdown layer to be present on both sides of the separator. However, it has been determined to be advantageous for the shutdown layer to be present on only one side of the separator according to the present invention. A single shutdown layer is sufficient to ensure safe shutdown when needed.

The shutdown layer which according to the present invention is present on the inorganic layer can consist for example of natural or artificial waxes, (low-melting) polymers, for example specific polyolefins, such as for example polyethylene or polypropylene, or polymer blends or mixtures, in which case the material for the shutdown layer is chosen so that the shutdown layer will melt at the desired shutdown temperature and close the pores of the separator to prevent any further ion flux. Preferred materials for the shutdown layer are materials which have a melting point of not more than 180° C. and preferably of less than 130° C. The use of materials which cause shutdown at relatively low temperatures very substantially avoids any melting or ignition of materials (such as housings or cables for example) which surround the batteries. It is particularly preferable for the separator of the present invention to comprise a shutdown layer composed of polyethylene (wax).

Shutdown layer thickness is in principle freely choosable as long as it is ensured that there is no reduction in ion flux and hence separator conductivity which would result in reduced battery performance. Shutdown layer thickness is only critical insofar as an excessively thick layer would unnecessarily increase the resistance in the battery system. To achieve safe shutdown, the shutdown layer should be from 1 to 20 μm and preferably from 5 to 10 μm in thickness. It can be advantageous for the material of the shutdown layer and at least portions of the material of the carrier to be identical. Shutdown layer porosity is in the range from 20% to 80% and more preferably in the range from 40% to 60%.

The inventive separators are preferably produced by the inventive process for producing a separator, said process comprising a carrier which comprises woven or non-woven polymeric fibers being provided with a ceramic coating by a suspension being applied onto and into the carrier and being solidified on and in the carrier by at least single heating, the suspension comprising a sol and at least two fractions of particles of which the first fraction comprises oxidic particles having an average particle size in the range from 0.5 to 10 μm selected from the oxides of the elements Al, Zr and/or Si and comprises from 75 to 99 parts by mass, preferably from 85 to 90 parts by mass, and of which the second fraction comprises zeolite particles having an average particle size in the range from 0.5 to 10 μm and comprises from 1 to 25 parts by mass, preferably from 10 to 15 parts by mass. The step of solidifying the suspension converts the sol into the inorganic adhesive which adheres the particles to each other and to the carrier or any adhesion promoter or promoters present.

The production of separators or membranes is known in principle from WO 99/15262. However, the use described therein of electroconductive ingredients and flexible carriers, such as stainless steel for example, can lead to the production of separators which have only very limited if any usefulness for the production of the separators according to the present invention. The use of separators produced as per the process described hereinbelow will be found to be particularly advantageous.

The separators of the present invention are obtained by applying a suspension which inorganic nonelectroconductive particles to a porous nonelectroconductive carrier and then solidifying the suspension to form an inorganic coating on and in the porous carrier. Examples of ways in which the suspension may be applied to the carrier are printing on, pressing on, pressing in, rolling on, knife coating on, spread coating on, dipping, spraying or pouring on.

The carrier used is preferably less than 30 μm, more preferably less than 20 μm and even more preferably from 10 to 20 μm in thickness. It is particularly preferable to use carriers as described in relation to the description of the separator according to the present invention. The porous carrier used thus preferably comprises woven or non-woven polymeric fibers. It is particularly preferable to use a carrier which comprises a polymeric woven or nonwoven or is such a woven or nonwoven. The carrier used preferably comprises polymeric fibers having a softening temperature of above 100° C. and a melting temperature of above 110° C. It can be advantageous for the polymeric fibers to be from 0.1 to 10 μm and preferably from 1 to 5 μm in diameter. It is particularly preferable to use in the process of the present invention a carrier which comprises fibers selected from polyacrylonitrile, polyester, polyamide and/or polyolefin.

The suspension used for producing the coating comprises at least particles of Al₂O₃, ZrO₂ and/or SiO₂, at least one fraction of zeolite particles and at least one sol of the elements Al, Zr and/or Si and is produced by suspending the particles in at least one of these sols. The suspending is effected by intensive mixing of the components. The average size of the particles used is preferably in the range from 0.5 to 10 μm and more preferably in the range from 1 to 4 μm. The metal oxide particles used for producing the suspension are more preferably aluminum oxide particles, which preferably have an average particle size in the range from 0.5 to 10 μm, and more preferably from 1 to 4 μm. Aluminum oxide particles in the range of the preferred particle sizes are available for example from Martinswerke under the designations MZS 3 and MZS1 and from AlCoA under the designation CT3000 SG, CL3000 SG, CT1200 SG, CT800SG and HVA SG.

It has been determined that the use of commercially available oxidic particles leads to unsatisfactory results in certain circumstances, since the particle size distributions are frequently very wide. It is therefore preferable to use metal oxide particles which have been classified by a conventional process, for example wind sifting and hydroclassification. It is preferable to employ as oxidic particles those fractions where the coarse grain fraction, which accounts for up to 10% of the total amount, has been separated off by wet sieving. This unwelcome coarse grain fraction, which is very difficult or impossible to comminute even by the typical processes of slip production such as, for example, grinding (ball mill, attritor mill, pestle mill), dispersing (Ultra-Turrax, ultrasound), trituration or chopping, can consist for example of aggregates, hard agglomerates, grinding media attritus. The aforementioned measures ensure that the inorganic porous layer has a very uniform pore size distribution. This is achieved in particular by using oxidic particles whose maximum particle size is preferably from ⅓ to ⅕ and more preferably not more than 1/10 of the thickness of the nonwoven used.

Table 2 hereinbelow gives an overview of how the choice of the various aluminum oxides affects the porosity and the resulting pore size of the respective porous inorganic coating. To determine these data, the corresponding slips (suspensions or dispersions) were prepared and dried and solidified as pure moldings at 200° C.

TABLE 2
Typical data of ceramics as a function of powder type used

| Al₂O₃ type | Porosity/% | Average pore size/nm |
|---|---|---|
| AlCoA CL3000SG | 51 | 755 |
| AlCoA CT800SG | 53.1 | 820 |
| AlCoA HVA SG | 53.3 | 865 |
| AlCoA CL4400FG | 44.8 | 1015 |
| Martinsw. DN 206 | 42.9 | 1025 |
| Martinsw. MDS 6 | 40.8 | 605 |
| Martinsw. MZS 1 + | 47% | 445 |
| Martinsw. MZS 3 = 1:1 | | |
| Martinsw. MZS 3 | 48% | 690 |

By average pore size and the porosity are meant the average pore size and the porosity as may be determined by the known method of mercury porosimetry using for example a 4000 porosimeter from Carlo Erba Instruments. Mercury porosimetry is based on the Washburn equation (E. W. Washburn, “Note on a Method of Determining the Distribution of Pore Sizes in a Porous Material”, Proc. Natl. Acad. Sci., 7, 115-16 (1921)).

Useful zeolite particles include in principle particles of all known zeolites. Preference is given to using the less hydrophobic types of zeolites. The separator of the present invention is preferably produced using zeolite particles selected from the zeolites Zeolite-A, Zeolite-Y, Zeolite-USY. Some data for these preferred zeolite types are reported above in table 1. But other zeolites known from the prior art can be used as well. Zeolites are obtainable for example from Zeolyst under the name mentioned in table 1.

The zeolites can either be used in their typical supply form, for example as Na⁺ or H⁺ form, or they are converted into their Li⁺ form. To this end, the zeolites are initially converted into the Li form by repeated exchanging of the alkali or alkaline earth metal ions in a lithium salt solution. This can be accomplished at room temperature or at boiling heat. However, the conversion of the zeolites into their corresponding forms can also take place after the separator is ready produced. The zeolites are either supplied by the manufacturer in the appropriate particle size or else have to be ground down to the desired size, i.e., to an average particle size in the range from 0.5 to 10 μm. This can be accomplished using known techniques (ball mill, attritor mill).

The mass fraction of the suspended components (particles) is preferably from 1 to 250 times and more preferably from 1 to 50 times the sol used.

The sols are obtained by hydrolyzing at least one (precursor) compound of the elements Zr, Al and/or Si. It can be advantageous for the compound to be hydrolyzed to be introduced into alcohol or an acid or a combination thereof prior to hydrolysis. The compound to be hydrolyzed is preferably at least one nitrate, one chloride, one carbonate or one alkoxide compound of the elements Zr, Al and/or Si. The hydrolysis is preferably carried out in the presence of liquid water, water vapor, ice, alcohol or an acid or a combination thereof. Preferably, the sols are obtained by hydrolyzing a compound of the elements Al, Zr or Si using water or a water-diluted acid, the compounds preferably being present dissolved in a nonaqueous or optionally even anhydrous solvent and being hydrolyzed with from 0.1 to 100 times the molar ratio of water.

In one version of the process for producing the separator of the present invention, particulate sols are produced by hydrolysis of the compounds to be hydrolyzed. These particulate sols are so called because the compounds formed by hydrolysis in the sol are present in particulate form. Particulate sols can be prepared as described above or in WO 99/15262. These sols customarily have a very high water content, which is preferably above 50% by weight. It can be advantageous for the compound to be hydrolyzed to be introduced into alcohol or an acid or a combination thereof prior to hydrolysis. The hydrolyzed compound may be peptized by treatment with at least one organic or inorganic acid, preferably with a 5-50% organic or inorganic acid, more preferably with a mineral acid selected from sulfuric acid, hydrochloric acid, perchloric acid, phosphoric acid and nitric acid or a mixture thereof. The particulate sols thus produced can subsequently be used to produce suspensions, in which case it is preferable to produce suspensions for application to polymeric fiber nonwovens which have been pretreated with polymeric sol.

In a further version of the process for producing a separator which can be used according to the present invention, polymeric sols are produced by hydrolysis of the compounds to be hydrolyzed. These polymeric sols are so called because the compounds formed by hydrolysis in the sol are present in polymeric form, i.e., in the form of chains crosslinked across a relatively large space. Polymeric sols customarily contain less than 50% by weight, preferably much less than 20% by weight, of water and/or aqueous acid. To obtain the preferred fraction of water and/or aqueous acid, the hydrolysis is preferably carried out in such a way that the compound to be hydrolyzed is hydrolyzed with from 0.5 to 10 times the molar ratio and preferably with half the molar ratio of liquid water, water vapor or ice, based on the hydrolyzable group of hydrolyzable compound. The amount of water used can be up to 10 times in the case of compounds which are very slow to hydrolyze, such as tetraethoxysilane for example. Compounds which are very quick to hydrolyze, such as zirconium tetraethoxide, may well form particulate sols under these conditions, for which reason 0.5 times the amount of liquid water is preferably used to hydrolyze such compounds. A hydrolysis with less than the preferred amount of liquid water, water vapor or ice likewise leads to good results, although using more than 50% less than the preferred amount of half the molar ratio is possible but not very sensible, since hydrolysis would no longer be complete and coatings based on such sols would not be very stable.

To produce these sols having the desired very low fraction of water and/or acid in the sol, it is preferable for the compound to be hydrolyzed to be dissolved in an organic solvent, especially ethanol, isopropanol, butanol, amyl alcohol, hexane, cyclohexane, ethyl acetate or mixtures thereof, before the actual hydrolysis is carried out. A sol thus produced can be used for producing the suspension of the present invention or as an adhesion promoter in a pretreatment step. It is particularly preferable to use a suspension for producing the inventive separator which comprises a polymeric sol of a compound of silicon.

Both particulate sols and polymeric sols are useful as a sol in the inventive process for preparing the suspension. As well as sols obtainable as just described, it is in principle also possible to use commercially available sols, for example zirconium nitrate sol or silica sol. The process of producing separators which are particularly useful in the process of the present invention by applying a suspension to, and solidifying it on, a carrier is known per se from DE 10142622 and in similar form from WO 99/15262, but not all the parameters and ingredients are applicable to the production of the separator used in the process of the present, invention. More particularly, the operation described in WO 99/15262 is in that form not fully applicable to polymeric nonwoven materials, since the very watery sol systems described therein frequently do not permit complete, in-depth wetting of the customarily hydrophobic polymeric nonwovens, since most polymeric nonwovens are only badly wetted by very watery sol systems, if at all. It has been determined that even the minutest unwetted areas in the nonwoven material can lead to membranes and separators being obtained that have defects (such as holes or cracks, for example) and hence are inutile.

It has been found that a sol system or suspension whose wetting behavior has been adapted to the polymers will completely penetrate the carrier materials and especially the nonwoven materials and so provide defect-free coatings. In the inventive process it is therefore preferable to adapt the wetting behavior of the sol or suspension. This is preferably accomplished by producing polymeric sols or suspensions from polymeric sols, these sols comprising one or more alcohols, for example, methanol, ethanol or propanol or mixtures thereof. But other solvent mixtures are conceivable as well for addition to the sol or suspension in order that the wetting behavior thereof may be adapted to the nonwoven used.

It has been determined that the fundamental change to the sol system and to the suspension resulting therefrom leads to a distinct improvement in the adhesion properties of the ceramic components on the and in a polymeric nonwoven material. Such good adhesive strengths are normally not obtainable with particulate sol systems. It is therefore preferable for the nonwovens which are used in the invention, which comprise polymeric fibers, to be coated by means of suspensions which are based on polymeric sols or have been endowed with an adhesion promoter in a preceding step by treatment with a polymeric sol.

To improve the adhesion of the inorganic components to polymeric fibers or nonwovens as substrate, but also to improve the adhesion of a shutdown layer to be applied later, it may be preferable for the suspensions used to be admixed with adhesion promoters, for example organofunctional silanes, for example the Degussa silanes GLYMO, MEMO, AMEO, VTEO or Silfin. The admixing of adhesion promoters is preferable in the case of suspensions based on polymeric sols. Useful adhesion promoters include especially compounds selected from the octylsilanes, the vinylsilanes, the amine-functionalized silanes and/or the glycidyl-functionalized silanes, for example the Dynasilanes from Degussa. Particularly preferred adhesion promoters are vinyl-, methyl- and octylsilanes for polyethylene (PE) and polypropylene (PP) (although the exclusive use of methylsilanes is not optional), amine-functional silanes for polyamides and polyamines and glycidyl-functionalized silanes for polyacrylates, polyacrylonitrile and polyesters. Other adhesion promoters can be used as well, but they have to be adapted to the respective polymers. Adhesion promoters have to be chosen such that the solidification temperature is below the melting or softening temperature of the polymer used as a substrate and below the decomposition temperature of the polymer. The adhesion promoters used are especially the silanes listed in table 1. Preferably, suspensions according to the present invention contain very much less than 25% by weight and preferably less than 10% by weight of compounds capable of acting as adhesion promoters. An optimal fraction of adhesion promoter results from coating the fibers and/or particles with a monomolecular layer of adhesion promoter. The amount in grams of adhesion promoter required for this purpose can be obtained by multiplying the amount (in g) of the oxides or fibers used by the specific surface area of the materials (in m² g⁻¹) and then dividing by the specific area required by the adhesion promoters (in m² g⁻¹), the specific area required frequently being in the range from 300 to 400 m² g⁻¹ in order of magnitude.

Table 3 below contains an illustrative selection of preferred adhesion promoters based on organofunctional silicon compounds for typical polymers used as a nonwoven material.

TABLE 3

| Polymer | Organofunctional type | Adhesion promoter |
|---|---|---|
| PAN | glycidyl | GLYMO |
| | methacryloyl | MEMO |
| PA | amino | AMEO, DAMO |
| PET | methacryloyl | MEMO |
| | vinyl | VTMO, VTEO, VTMOEO |
| PE, PP | amino | AMEO, AMMO |
| | vinyl | VTMO, VTEO, Silfin |
| | methacryloyl | MEMO |

where:
AMEO = 3-aminopropyltriethoxysilane
DAMO = 2-aminoethyl-3-aminopropyltrimethoxysilane
GLYMO = 3-glycidyloxytrimethoxysilane
MEMO = 3-methacryloyloxypropyltrimethoxysilane
Silfin = vinylsilane + initiator + catalyst
VTEO = vinyltriethoxysilane
VTMO = vinyltrimethoxysilane
VTMOEO = vinyltris(2-methoxyethoxy)silane

The suspension present on and in the carrier as a result of having been applied thereto (the coating) can be solidified by heating to a temperature in the range from 50 to 350° C. for example. Since, when polymeric substrate materials are used, the maximum allowable temperature is dictated by the softening/melting temperature of this carrier material, the maximum allowable temperature has to be adapted accordingly. Thus, depending on the embodiment of the process, the suspension present on and in the nonwoven is solidified by heating at from 100 to 350° C. and most preferably by heating at from 200 to 280° C. It may be preferable for the heating to take place at from 150 to 350° C. for from 1 second to 60 minutes. It is particularly preferable to solidify the suspension by heating at from 110 to 300° C. and most preferably at from 150 to 280° C. and preferably for from 0.5 to 10 min. Heating the suspension preferably takes from 0.5 to 10 minutes at from 200 to 220° C. on a polymeric nonwoven comprising fibers composed of polyester, and from 0.5 to 10 minutes at from 170 to 200° C. on a polymeric nonwoven comprising fibers composed of polyamide. The heating of the assembly may be effected by means of heated air, hot air, infrared radiation or by other heating methods according to the prior art.

The process for producing separators used in the process of the present invention can be carried out for example by unrolling the carrier off a reel, passing it at a speed in the range from 1 m/h to 2 m/s, preferably at a speed in the range from 0.5 m/min to 20 m/min and most preferably at a speed in the range from 1 m/min to 5 m/min through at least one apparatus which applies the suspension onto and into the carrier, for example a roll, and at least one further apparatus which enables the suspension to be solidified on and in the carrier by heating, for example an electrically heated furnace, and rolling the separator thus produced up on a second reel. This makes it possible to produce the separator in a continuous process. Similarly, the pretreatment steps can be carried out as a continuous process while retaining the parameters mentioned.

In contrast to processes which do not utilize zeolite particles, it is necessary with the present process to provide for sufficiently long drying, so that the zeolite present in the separator is free of water after the separator has been produced. This is accomplished through prolonged residence times in an oven at the stated temperature (i.e., for example through the use of an oven of appropriate length) or else by supplementary tempering at from 40 to 100° C. at a relative humidity in the range from 0.1% to 5%. Preferably, the separator produced is stored in a water-free state (<1% relative humidity), since the separator will tend to absorb water from the atmosphere because of the presence of zeolite, especially when a relatively hydrophilic zeolite has been used. Water absorption would rule out a potential use in lithium ion batteries.

The separators of the present invention can also be endowed with a shutdown layer. The separators produced according to the present invention, unless they were produced using an adhesion promoter, will frequently comprise inorganic coatings which will be very hydrophilic in character. To ensure good adhesion of the porous sheetlike structure of the shutdown layer to hydrophilic porous inorganic layers, there are a number of possible variants.

In one variant for carrying out the process according to the present invention, it will be advantageous for the porous inorganic layer to be hydrophobicized before the shutdown layer is applied to it. The production of hydrophobic membranes which may serve as a starting material for producing the separators of the present invention is described for example in WO 99/62624. Preferably, the porous inorganic layer is hydrophobicized by treatment with alkyl-, aryl- or fluoroalkylsilanes marketed for example by Degussa under the trade name of Dynasilan. It is possible in this context to employ for example the familiar hydrophobicization methods which are employed inter alia for textiles (D. Knittel; E. Schollmeyer; Melliand Textilber. (1998) 79(5), 362-363), with minimal changes to the recipes, for porous permeable composites produced for example by the process described in PCT/EP98/05939. To this end, a permeable composite material (membrane or separator) is treated with a solution which comprises at least one hydrophobic material. It may be preferable for the solvent in the solution to be water, preferably adjusted to a pH in the range from 1 to 3 with an acid, preferably acetic acid or hydrochloric acid, and/or an alcohol, preferably ethanol. The solvent fraction attributable to acid-treated water or to alcohol may in each case be in the range from 0% to 100% by volume. Preferably, the fraction of the solvent which is attributable to water is in the range from 0% to 60% by volume and the fraction of solvent which is attributable to alcohol is in the range from 40% to 100% by volume. The solvent has introduced into it from 0.1 to 30% by weight and preferably from 1% to 10% by weight of a hydrophobic material to prepare the solution. Useful hydrophobic materials include for example the silanes recited above. Surprisingly, good hydrophobicization is obtained not just with strongly hydrophobic compounds such as for example triethoxy(3,3,4,4,5,5,6,6,7,7,8,8-tridecafluorooctyl)silane, but a treatment with methyl-triethoxysilane, octyltriethoxysilane or i-butyltriethoxysilane is completely sufficient to obtain the desired effect. The solutions are stirred at room temperature to achieve uniform dissipation of the hydrophobic materials in the solution and are subsequently applied to the porous inorganic layer and dried. The drying can be speeded by a treatment at temperatures in the range from 50 to 350° C. and preferably in the range from 150 to 200° C.

In a further variant of carrying out the process according to the present invention, the porous inorganic layer can also be treated with other adhesion promoters before the shutdown layer is applied. The treatment with one of the adhesion promoters mentioned in table 1 can then likewise be carried out as described above, i.e., by treating the porous inorganic layer with a polymeric sol which comprises a silane adhesion promoter. More particularly, the treatment can be carried out by using adhesion promoters in the production of the separator as described above. Adhesion promoters are preferably selected from hydrolyzed or nonhydrolyzed functionalized alkyltrialkoxysilanes. It is particularly preferred to use MEMO, AMEO and/or GLYMO as an adhesion promoter.

However, such a heat treatment can also be necessary to activate the silane adhesion promoters in order that they adhere the shutdown layer to the ceramic separator.

A preferred embodiment utilizes MEMO as adhesion promoter between the shutdown layer and the ceramic separator. When MEMO is used, activation is accomplished by means of UV light at a preferred wavelength of 200-300 nm.

The shutdown layer can be for example a porous sheetlike structure or a layer of particles, in which case the sheetlike structure or the particles consist of a material which melts at a certain temperature. The shutdown layer based on a porous sheetlike structure is preferably created on the porous inorganic layer of the separator by applying a porous sheetlike structure such as a woven, a formed-loop knit, a felt, a nonwoven or a porous foil to the porous inorganic layer. The shutdown layer can be applied by placing or laminating the porous sheetlike structure onto the porous inorganic layer. The laminating can be carried out at room temperature or at elevated temperature below the melting temperature of the material of the sheetlike structure. In the case of laminating, the abovementioned adhesion promoters can be used as laminating agents. The adhesion promoters can be selected from the known series of the alkyltrialkoxysilanes. These adhesion promoters are preferably present in the form of solutions or sols and are either first applied to the polymer or to the separator and solidified there or the silanes are introduced directly before or in the course of the laminating to adhere the polymer and the ceramic together. Examples of suitable silanes are available from Degussa as pure products or as aqueous solutions of the hydrolyzed silane for example under the designation Dynasilane 2926, 2907 or 2781.

Irrespective of whether the porous sheetlike structure is laminated on (with or without use of a laminating agent) or placed on the inorganic layer, the shutdown layer can be fixed on the porous inorganic layer after it has been applied to the porous inorganic layer by single heating to a temperature above the glass transition temperature, so that incipient melting of the material without change in the actual shape of the porous sheetlike structure is achieved.

Another way of fixing the shutdown layer to the porous inorganic layer of the separator is for example to place the shutdown layer on the porous inorganic layer and fix it in place by it being wound in during the fabrication of the battery.

Useful materials for the shutdown layer include all materials having a defined melting point. The material for the shutdown layer is chosen according to the desired shutdown temperature. Since relatively low shutdown temperatures are desired for most batteries, it is advantageous to use porous sheetlike structures as a material for a shutdown layer which are selected from polymers, polymer blends, natural and/or artificial waxes. These preferably have a melting temperature of not more than 180° C., preferably less than 150° C. and most preferably less than 130° C. It is particularly preferable to use shutdown layers composed of polypropylene (wax) or polyethylene (wax). Possible suppliers for such polymeric sheetlike structures are typical nonwovens suppliers such as Freudenberg or manufacturers of organic separators such as Celgard, DSM, Asahi or Ube. As stated above, it can be advantageous when the material which makes up the porous sheetlike structure is identical to at least a portion of the material of the carrier.

The applying of the porous sheetlike structure and any adhesion promoters and also any heating can be carried out continuously or quasi-continuously. When a flexible separator is used as a starting material, it can in turn be unwound off a reel, led through a coating, drying and, if appropriate, heating apparatus and then rolled up again.

In another preferred embodiment of the process according to the present invention, the separator according to the present invention is endowed with a shutdown function by particles having a defined, desired melting temperature being applied and fixed as shutdown particles. When the separators of the present invention were produced without use of an adhesion promoter, it comprises a ceramic coating which frequently has a very hydrophilic character. To achieve good adhesion and uniform distribution of the shutdown particles in the shutdown layer on hydrophilic porous inorganic layers as well, there are a number of possible variants.

In one variant of carrying out the process according to the present invention, it will be advantageous for the porous inorganic layer to be hydrophobicized before the shutdown particles are applied to it. The production of hydrophobic membranes which may serve as a starting material for producing the separators of the present invention is described for example in WO 99/62624. Preferably, the porous inorganic layer is hydrophobicized by treatment with alkyl-, aryl- or fluoroalkylsilanes marketed for example by Degussa under the trade name of Dynasilan. It is possible in this context to employ for example the familiar hydrophobicization methods which are employed inter alia for textiles (D. Knittel; E. Schollmeyer; Melliand Textilber. (1998) 79(5), 362-363), with minimal changes to the recipes, for porous permeable composites produced for example by the process described in PCT/EP98/05939. To this end, a permeable composite material (membrane or separator) is treated with a solution which comprises at least one hydrophobic material. It may be preferable for the solvent in the solution to be water, preferably adjusted to a pH in the range from 1 to 3 with an acid, preferably acetic acid or hydrochloric acid, and/or an alcohol, preferably ethanol. The solvent fraction attributable to acid-treated water or to alcohol may in each case be in the range from 0% to 100% by volume. Preferably, the fraction of the solvent which is attributable to water is in the range from 0% to 60% by volume and the fraction of solvent which is attributable to alcohol is in the range from 40% to 100% by volume. The solvent has introduced into it from 0.1 to 30% by weight and preferably from 1% to 10% by weight of a hydrophobic material to prepare the solution. Useful hydrophobic materials include for example the silanes recited above. Surprisingly, good hydrophobicization is obtained not just with strongly hydrophobic compounds such as for example triethoxy(3,3,4,4,5,5,6,6,7,7,8,8-tridecafluorooctyl)silane, but a treatment with methyltriethoxysilane or i-butyltriethoxysilane is completely sufficient to obtain the desired effect. The solutions are stirred at room temperature to achieve uniform dissipation of the hydrophobic materials in the solution and are subsequently applied to the porous inorganic layer and dried. The drying can be speeded by a treatment at temperatures in the range from 25 to 100° C.

In a further version of the process according to the present invention, the porous inorganic layer can also be treated with other adhesion promoters before the shutdown particles are applied to it. The treatment with one of the adhesion promoters mentioned in table 1 can then likewise be effected as described above, i.e., by treating the porous inorganic layer with a polymeric sol which comprises a silane adhesion promoter. More particularly, the treatment can be effected by using adhesion promoters in the production of the separator as described above.

The layer of shutdown particles is preferably produced by applying a suspension of shutdown particles in a suspension medium selected from a sol, water or solvent, for example alcohol, hydrocarbons, ethers or ketones or a solvent mixture. The particle size of the shutdown particles present in the suspension is freely choosable in principle. However, it is advantageous for the suspension to contain shutdown particles having an average particle size (D_{w}) which is greater than the average pore size of the pores in the porous inorganic layer (dₛ), since this ensures that the pores in the inorganic layer are not clogged by shutdown particles in the course of the production of the separator according to the present invention. The shutdown particles used preferably have an average particle size (D_{w}) which is greater than the average pore diameter (dₛ) and less than 5 dₛ and more preferably less than 2 dₛ.

The solvent used for the dispersion is preferably water. These aqueous dispersions are adjusted to a polymer or wax content in the range from 1% to 60%, preferably from 5% to 50% and most preferably from 20% to 40% by weight. When water is used as a solvent, it is very simple to obtain in the dispersion the preferred average particle sizes from 1 to 10 μm which are very highly suitable for the separators of the present invention.

Using a nonaqueous solvent for producing the wax or polymer dispersion is a preferable way of obtaining average particle sizes of less than 1 μm in the dispersion. It is similarly possible to use mixtures of nonaqueous solvents with water.

To employ shutdown particles smaller in size than the pores in the porous inorganic layer, the particles must be prevented from penetrating into the pores in the porous inorganic layer. Reasons for using such particles can reside for example in large price differences but also in the availability of such particles. One way of preventing the penetration of shutdown particles into the pores in the porous inorganic layer is to adjust the viscosity of the suspension such that absent external shearing forces no penetration of the suspension into the pores in the inorganic layer takes place. Such a high viscosity for the suspension is obtainable for example by adding auxiliaries which influence the flow behavior, for example silicas (Aerosil, Degussa), to the suspension. When auxiliaries are used, for example Aerosil 200, a fraction from 0.1% to 10% by weight and preferably from 0.5 to 50% by weight of silica, based on the suspension, will frequently be sufficient to achieve a sufficiently high viscosity for the suspension. The fraction of auxiliaries can in each case be determined by simple preliminary tests.

It may be preferable for the shutdown particle suspension used to contain adhesion promoters. Such a suspension with adhesion promoter can be applied directly to a separator even when the separator was not hydrophobicized beforehand. It will be appreciated that a suspension with adhesion promoter can also be applied to a hydrophobicized separator or to a separator which has been produced using an adhesion promoter. Adhesion promoters used in the shutdown particle suspension are preferably silanes having amino, vinyl or methacryloyl side groups. Such silanes are obtainable for example from Degussa as pure products or as aqueous solutions of the hydrolyzed silane under for example the designation Dynasilan 2926, 2907 or 2781. An adhesion promoter fraction of not more than 10% by weight in the suspension has been determined to be sufficient for ensuring sufficient adhesion of the shutdown particles to the porous inorganic layer. Shutdown particle suspensions with adhesion promoter preferably contain from 0.1% to 10% by weight, more preferably from 1% to 7.5% by weight and most preferably from 2.5% to 5% by weight of adhesion promoter, based on the suspension.

Useful shutdown particles include all particles having a defined melting point. The particle material is chosen according to the shutdown temperature desired. Since relatively low shutdown temperatures are desired for most batteries, it is advantageous to use shutdown particles selected from particles of polymers, polymer blends, natural and/or artificial waxes. Particularly preferred shutdown particles are particles of polypropylene wax or particles of polyethylene wax.

The shutdown particle suspension may be applied to the porous inorganic layer by printing on, pressing on, pressing in, rolling on, knifecoating on, spreadcoating on, dipping, spraying or pouring on. The shutdown layer is preferably obtained by drying the applied suspension at a temperature in the range from room temperature to 100° C. and preferably in the range from 40 to 60° C. The drying operation has to be carried out in such a way that the shutdown particles do not melt.

It may be preferable for the particles to be fixed after they have been applied to the porous ceramic coating, by heating one or more times to a temperature above the glass transition temperature, so that the particles are fused on without undergoing a change in their actual shape. This makes it possible to ensure that the shutdown particles bond particularly firmly to the porous inorganic layer.

The applying of the suspension with subsequent drying and any heating to above the glass transition temperature can be carried out continuously or quasi-continuously, equivalently to the production of the separator itself, by the separator again being unwound off a reel, led through a coating, drying and, if appropriate, heating apparatus and then rolled up again.

The separators according to the present invention and the separators produced according to the present invention can be used as a separator in batteries, especially as a separator in lithium batteries, preferably lithium high power and high energy batteries. Such lithium batteries may comprise an electrolyte comprising lithium salts having large anions in carbonate solvents. Examples of suitable lithium salts are LiClO₄, LiBF₄, LiAsF₆ or LiPF₆, of which LiPF₆ is particularly preferred. Examples of organic carbonates useful as solvents are ethylene carbonate, propylene carbonate, dimethyl carbonate, ethyl methyl carbonate or diethyl carbonate or mixtures thereof.

The present invention also provides batteries, especially lithium batteries, comprising a separator according to the invention or produced according to the invention.

The present invention is described by the examples which follow without being restricted thereto.

### EXAMPLES

### Comparative Example

### Separator According to Prior Art

To 130 g of water and 15 g of ethanol were initially added 30 g of a 5% by weight aqueous HNO₃ solution, 10 g of tetraethoxysilane, 2.5 g of methyltriethoxysilane and 7.5 g of GLYMO dynasilane (Degussa AG). This sol, which was initially stirred for some hours, was then used to suspend 125 g each of the aluminum oxides Martoxid MZS-1 and Martoxid MZS-3 (Martinswerke). This slip was homogenized with a magnetic stirrer for at least a further 24 h, during which the stirred vessel had to be covered over in order that no solvent loss occurred.

The above slip was then used to coat a 20 cm wide PET nonwoven (Freudenberg Vliesstoffe KG) having a thickness of about 20 μm and a basis weight of about 15 g/m² in a continuous roll coating process at a belt speed of about 30 m/h and T=200° C. The end result obtained was a separator having an average pore size of 450 nm.

### Inventive Example 1

To 195 g of water and 15 g of ethanol were initially added 30 g of a 5% by weight aqueous HNO₃ solution, 10 g of tetraethoxysilane, 2.5 g of methyltriethoxysilane and 7.5 g of GLYMO dynasilane (Degussa AG). This sol, which was initially stirred for some hours, was then used to suspend 113 g each of the aluminum oxides Martoxid MZS-1 and Martoxid MZS-3 (Martinswerke) and also 25 g of CBV600 zeolite (Zeolyst). This slip was homogenized with a magnetic stirrer for at least a further 24 h, during which the stirred vessel had to be covered over in order that no solvent loss occurred.

The above slip was then used to coat a 20 cm wide PET nonwoven (Freudenberg Vliesstoffe KG) having a thickness of about 20 μm and a basis weight of about 15 g/m² in a continuous roll coating process at a belt speed of about 30 m/h and T=220° C. The end result obtained was a separator having an average pore size of 450 nm.

### Inventive Example 2

To 195 g of water and 15 g of ethanol were initially added 30 g of a 5% by weight aqueous HNO₃ solution, 10 g of tetraethoxysilane, 2.5 g of methyltriethoxysilane and 7.5 g of GLYMO dynasilane (Degussa AG). This sol, which was initially stirred for some hours, was then used to suspend 106 g each of the aluminum oxides Martoxid MZS-1 and Martoxid MZS-3 (Martinswerke) and also 38 g of CBV600 zeolite (Zeolyst). This slip was homogenized with a magnetic stirrer for at least a further 24 h, during which the stirred vessel had to be covered over in order that no solvent loss occurred.

The above slip was then used to coat a 20 cm wide PET nonwoven (Freudenberg Vliesstoffe KG) having a thickness of about 20 μm and a basis weight of about 15 g/m² in a continuous roll coating process at a belt speed of about 30 m/h and T=220° C. The end result obtained was a separator having an average pore size of 450 nm.

### Inventive Example 3

To 163 g of water and 15 g of ethanol were initially added 30 g of a 5% by weight aqueous HNO₃ solution, 10 g of tetraethoxysilane, 2.5 g of methyltriethoxysilane and 7.5 g of GLYMO dynasilane (Degussa AG). This sol, which was initially stirred for some hours, was then used to suspend 113 g each of the aluminum oxides Martoxid MZS-1 and Martoxid MZS-3 (Martinswerke) and also 25 g of CBV712 zeolite (Zeolyst). This slip was homogenized with a magnetic stirrer for at least a further 24 h, during which the stirred vessel had to be covered over in order that no solvent loss occurred.

The above slip was then used to coat a 20 cm wide PET nonwoven (Freudenberg Vliesstoffe KG) having a thickness of about 20 μm and a basis weight of about 15 g/m² in a continuous roll coating process at a belt speed of about 30 m/h and T=220° C. The end result obtained was a separator having an average pore size of 450 nm.

### Inventive Example 4

To 195 g of water and 15 g of ethanol were initially added 30 g of a 5% by weight aqueous HNO₃ solution, 10 g of tetraethoxysilane, 2.5 g of methyltriethoxysilane and 7.5 g of GLYMO dynasilane (Degussa AG). This sol, which was initially stirred for some hours, was then used to suspend 113 g each of the aluminum oxides Martoxid MZS-1 and Martoxid MZS-3 (Martinswerke) and also 25 g of CBV3024 zeolite (Zeolyst). This slip was homogenized with a magnetic stirrer for at least a further 24 h, during which the stirred vessel had to be covered over in order that no solvent loss occurred.

The above slip was then used to coat a 20 cm wide PET nonwoven (Freudenberg Vliesstoffe KG) having a thickness of about 20 μm and a basis weight of about 15 g/m² in a continuous roll coating process at a belt speed of about 30 m/h and T=220° C. The end result obtained was a separator having an average pore size of 450 nm.

### Example 5

### Characterization of Separators

| Separator | LF* | | Thickness | BP | Add-on | |
|---|---|---|---|---|---|---|
| as per | MS/cm | MacMullin* | μm | bar | g/m² | Gurleys |
| Comparison | 0.032 | 3.8 | 55 | 0.8 | 55 | 11.2 |
| Example 1 | 0.046 | 2.7 | 46 | | 26 | 5.5 |
| Example 2 | 0.053 | 2.3 | 46 | | 31 | |
| Example 3 | 0.047 | 2.6 | 49 | | 32 | |
| Example 4 | 0.036 | 3.4 | 47 | 0.5 | 34 | 13.7 |

*The samples were previously dried anhydrous, the electrolyte used is a 0.01 molar solution of LiClO₄ in propylene carbonate

### Determination of MacMullin Number:

First the conductivity LF1 of the pure electrolyte (a 0.01 molar solution of LiClO₄ in propylene carbonate) was determined at 30° C. using a Metrohm conductometer. Then the separator was saturated with electrolyte and likewise measured for its conductivity, LF2. The MacMullin number is the ratio of these two conductivities LF1/LF2.

### Determination of BP:

The bubble point (BP) is that pressure in bar at which a gas bubble passes through a completely wetted membrane (separator). The bubble point is a measure of the size of the largest pore or defect in a membrane. The smaller the BP, the larger the largest pore or largest defect (hole).

The bubble point was measured by trimming a membrane to a 30 mm diameter size. The trimmed membrane was then immersed in the wetting liquid (completely ion-free water) for at least one day. The membrane thus prepared was installed in an apparatus between a round sintered metal disk having a BP of about 0 bar (measurement without membrane), which serves as a support material, and a silicone rubber seal, the apparatus containing above the membrane a vessel which was open at the top, which had the same cross-section as the membrane and which was filled with 2 cm of completely ion-free water and below the membrane a second vessel which likewise had the same cross-section as the membrane and which was equipped with an air inlet by which compressed air could be passed into the vessel via a pressure reduction valve. The membrane was installed underneath the sintered metal disk, so that the sintered metal disk formed the bottom of the upper vessel and the membrane sealed off the lower vessel. The pressure was then raised in the lower vessel in 0.1 bar increments at half minute intervals between each increase in pressure. After each increase in pressure, the water surface in the upper vessel was observed for about half a minute. As soon as the first small gas bubbles appear at the water surface, the BP pressure is reached and the measurement was discontinued.

Determination of Gurley number

The Gurley number was determined in the same apparatus as BP. However, the time t was determined which a gas volume of 100 ml requires to pass through a 6.45 cm² area at a 31 cm hydrohead gas pressure. The time t is the Gurley number.

As is discernible from the table, a significant increase in conductivity was found in all cases where zeolites were used. It can be easily seen that the use of CBV600 (as per inventive example 2) can raise the conductivity by 65%, compared with the comparative example without zeolite. The MacMullin number also decreases correspondingly.

1. A separator for electrochemical cells comprising a porous carrier which comprises woven or non-woven polymeric fibers having on and in this carrier a porous inorganic nonelectroconductive coating comprising particles having an average particle size in the range from 0.5 to 10 μm which are adhered to each other and to the carrier by an inorganic adhesive,
wherein
the inorganic coating comprises from 75 to 99 parts by mass of one or more oxidic particles of the elements Al, Si and/or Zr having an average particle size in the range from 0.5 to 10 μm and from 1 to 25 parts by mass of particles having an average particle size in the range from 0.5 to 10 μm of at least one zeolite.

2. The separator of claim 1,
wherein
the zeolites in the zeolite particles are in the Na⁺ or Li⁺ form.

3. The separator of claim 1,
wherein
the carrier is flexible and less than 50 μm in thickness.

4. The separator according to claim 3,
wherein
the carrier is polymeric nonwoven fibers.

5. The separator according to claim 1,
wherein
the polymeric fibers of the carrier are fibers selected from the group consisting of polyacrylonitrile, polyamide, polyester, polyolefin, and combinations thereof.

6. The separator according to claim 1,
wherein
the inorganic adhesives are selected from oxides of the elements Al, Si and/or Zr.

7. The separator of claim 1,
wherein
the inorganic adhesive comprises particles having an average particle size of less than 20 nm and is prepared by a particulate sol or comprises an inorganic network of oxides prepared by a polymeric sol.

8. The separator of claim 1,
which further comprises an inorganic network comprising silicon, the silicon of the network being bonded by oxygen atoms to the oxides of the inorganic coating and by an organic radical to the carrier which comprises polymeric fibers.

9. The separator of claim 1,
wherein
the zeolite particles are selected from the zeolites Zeolite-A, Zeolite-Y, Zeolite-USY, ZSM-5 or ZSM-9.

10. The process for producing a separator of claim 1,
comprising steps of
coating a carrier which comprises woven or non-woven polymeric fibers with a ceramic coating applied by a suspension onto and into the carrier and
heating and solidifying the suspension on and in the carrier, the suspension comprising a sol and at least two fractions of particles of which the first fraction comprises oxidic particles having an average particle size in the range from 0.5 to 10 μm selected from the oxides of the elements Al, Zr and/or Si and comprises from 75 to 99 parts by mass and of which the second fraction comprises zeolite particles having an average particle size in the range from 0.5 to 10 μm and comprises from 1 to 25 parts by mass.

11. The process according to claim 10,
further comprising the step of
adding an adhesion promoter selected from the organofunctional silanes to the suspension before it is applied to the carrier.

12. The process according to claim 11,
wherein
the adhesion promoter is selected from the group consisting of 3-aminopropyltriethoxysilane, 2-aminoethyl-3-aminopropyltrimethoxysilane, 3-glycidyloxytrimethoxysilane, 3-methacryloyloxypropyltrimethoxysilane, vinyltriethoxysilane, vinyltrimethoxysilane and vinyltris(2-methoxyethoxy)silane.

13. The process according to claim 10,
wherein
the suspension is applied onto and into the carrier by printing on, pressing on, pressing in, rolling on, knifecoating on, spreadcoating on, dipping, spraying or pouring on.

14. The process according to claim 10,
wherein
the carrier comprises a polymeric nonwoven fiber selected from the group consisting of polyacrylonitrile, polyester, polyamide, polyolefin, and combinations thereof.

15. The process according to claim 10,
wherein
the suspension comprises at least one sol of a compound of the elements Al, Si, or Zr and is prepared by suspending the particles in at least one of these sols.

16. The process according to claim 15,
wherein
the sols are obtained by hydrolyzing a precursor compound of the elements Al, Zr or Si with water or with a water-diluted acid.

17. The process according to claim 15,
wherein
the suspension comprises a polymeric sol of a compound of silicon.

18. The process according to claim 16,
wherein
the sols are obtained by hydrolyzing a compound of the elements Al, Zr or Si with water or an acid or a combination thereof, the compounds being present dissolved in an anhydrous solvent and being hydrolyzed with from 0.1 to 100 times the molar ratio of water.

19. The process according to of claim 10,
comprising
heating and solidifying the suspension present on and in the carrier at from 50 to 350° C.

20. The process according to claim 19,
comprising
heating the suspension at a temperature in the range from 200 to 220° C. for from 0.5 to 10 minutes on polyester fibers.

21. The process according to claim 19,
comprising
heating the suspension at a temperature in the range from 130 to 180° C. for from 0.5 to 10 minutes on nonwoven polyamide fibers.

22. The method of using the separator of claim 1 as a separator in a battery.

23. A lithium battery comprising a separator of claim 1.
